(19) United States
(12) Patent Application Publication
(10) Pub. No.: US 2006/0121842 A1
(43) Pub. Date: Jun. 8, 2006

(54) Multi-sash fume hood drive system

(76) Inventors: Jeffrey L. Worland, Jamestown, NY (US); Eugene A. DeCastro, Jamestown, NY (US); Ronald Arredondo JR., Jamestown, NY (US)

Correspondence Address: The Bilicki Law Firm, P.C., 1285 North Main Street, Jamestown, NY, 14701, US

(21) Appl. No.: 11/001,743

(22) Filed: Dec. 2, 2004

(51) Int. Cl. F24F 7/00; B08B 15/02

(52) U.S. Cl. 454/56

(57) ABSTRACT

A fume hood comprised of a first and second side wall, a back wall, a top wall, all of which define a work area, an access opening for providing a user access to the work area, a multi-window movable sash member disposed for vertical movement across the access opening and to vary the effective size thereof, a plurality of window positioning mechanisms, one window positioning mechanisms for each of window, and a common drive mechanism to drive each window positioning mechanism and simultaneously raise or lower each window of the multi-window movable sash member.

### FIELD OF INVENTION

The present invention relates generally to a mechanical system that allows an operator to open and close a multi-window movable sash member of a fume hood. Specifically, the present invention relates to a single drive system that simultaneously raises each sash component of a multi-window movable sash member, but each at a different speed.

### BRIEF DESCRIPTION OF THE DRAWINGS

FIG. 1 shows a side view of a fume hood with one embodiment of a multi-window movable sash member.

FIG. 2 shows a top perspective view of the drive mechanism for raising and lowering the multi-window movable sash member.

### DETAILED DESCRIPTION OF EMBODIMENTS OF THE INVENTION

For the purpose of promoting an understanding of the present invention, reference will be made to embodiments of a multi-window movable sash member fume hood as illustrated by the following drawings. It will nevertheless be understood that no limitations of the scope of the invention are thereby intended by such alterations as (I) changing the geometry or any element of the embodiments of the invention, (II) the placement of the various components, (III) the quantity of each component, or (IV) the materials from which to make the various components. It is contemplated that such alterations fall within the spirit and scope of the invention described herein. Some of the possible alterations will be mentioned in the following description.

With particular reference to the drawings, the reader should understand that like numerals in different figures refer to the same elements of the various embodiments.

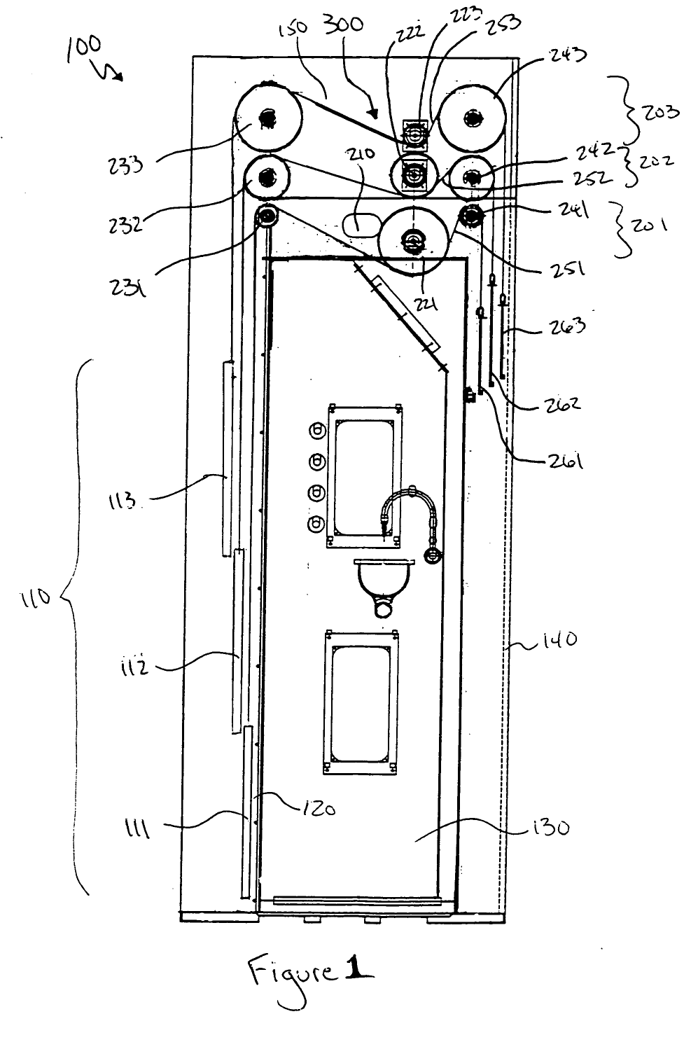

FIG. 1 shows a side view of an exemplary fume hood 100 in which one embodiment of multi-window movable sash member 110, in a closed position, can be seen. Also visible are access opening 120, side wall 130, back wall 140, and top wall 150. Multi-window movable sash member 110 is comprised of three windows, first window 111, second window 112, and third window 113. However, the number of windows of multi-window movable sash member 110 is not intended to be limiting. Rather, any number of windows can be used. Furthermore, as shown in FIG. 1, fume hood 100 is of a walk-in type, but this is not intended to be limiting, as the invention is applicable to any type of fume hood in which multi-window movable sash member 110 is employed, including fume hoods with a solid pedestal or base.

Also visible in FIG. 1 are drive motor 210, first drive wheel 221, second drive wheel 222, third drive wheel 223, first forward friction wheel 231, second forward friction wheel 232, third forward friction wheel 233, first rear friction wheel 241, second rear friction wheel 242, third rear friction wheel 243, first flexible coupling 251, second flexible coupling 252, third flexible coupling 253, first counterweight 261, second counterweight 262, and third counterweight 263. First flexible coupling 251 passes around and engages first forward friction wheel 231, first drive wheel 221, and first rear friction wheel 241. First flexible coupling 251 is connected to first window 111 of multi-window movable sash member 110 on a first end and to first counterweight 261 on a second end. First forward friction wheel 231, first drive wheel 221, first rear friction wheel 241, and first flexible coupling 251 comprise first window positioning mechanism 201.

Similarly, second forward friction wheel 232, second drive wheel 222, second rear friction wheel 242, and second flexible coupling 252 comprise second window positioning mechanism 202 and third forward friction wheel 233, third drive wheel 223, third rear friction wheel 243, and third flexible coupling 253 comprise third window positioning mechanism 203. Thus, there are as many window positioning mechanisms 201, 202, 203 as there are windows in multi-window movable sash member 110, i.e., one for each. In addition, for each window positioning mechanism 201, 202, 203, there is a second set of forward friction wheels (not shown), rear friction wheels (not shown), flexible couplings (not shown), and drive wheels (not shown) on the other side of fume hood 100, and at least one drive shaft (not shown) connecting one component of each window positioning mechanism 201, 202, 203 to its counterpart on the other side of fume hood 100. This combination of two window positioning mechanisms 201, 202, 203 and at least one drive shaft for each window 111, 112, 113 of multi-window movable sash member 110 is a “window positioning system.”

As first flexible coupling 251 is moved by drive motor 210, so are first forward friction wheel 231 and first rear friction wheel 241, raising or lowering first window 111 of multi-window movable sash member 110. Similarly, second flexible coupling 252 passes around and engages second forward friction wheel 232, second drive wheel 222, and second rear friction wheel 242. Second flexible coupling 252 is connected to second window 112 of multi-window movable sash member 110 on a first end and to second counterweight 262 on a second end. As second flexible coupling 252 is moved, second forward friction wheel 232 and second rear friction wheel 242 are also rotated, raising or lowering second window 112 of multi-window movable sash member 110. Finally, third flexible coupling 253 passes around and engages third forward friction wheel 233, third drive wheel 223, and third rear friction wheel 243. Third flexible coupling 253 is connected to third window 113 of multi-window movable sash member 110 on a first end and to third counterweight 263 on a second end. As third flexible coupling 253 is moved, third forward friction wheel 233 and third rear friction wheel 243 are also rotated, raising or lowering second window 113 of multi-window movable sash member 110.

Common drive mechanism 300 (described in greater detail infra) simultaneously drives all three flexible couplings 251, 252, 253 such that first is window 111, second window 112, and third window 113 of multi-window movable sash member 110 are raised simultaneously, but, in the embodiment shown, at different speeds.

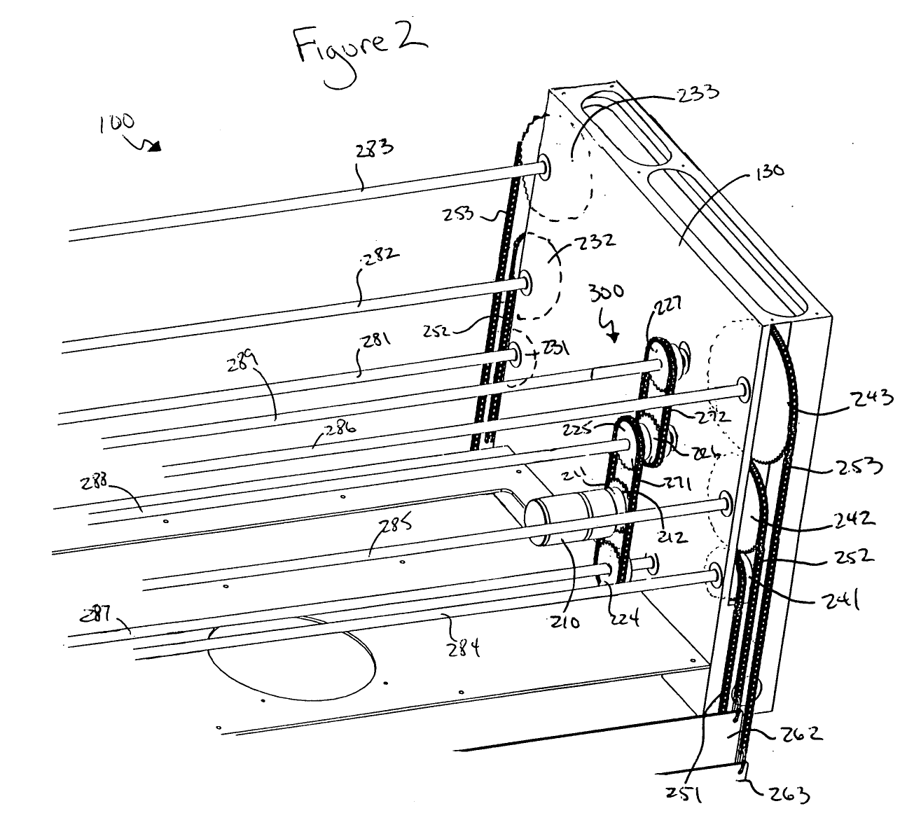

In one embodiment, as described supra, fourth, fifth, and sixth window positioning mechanisms are positioned on the other side of fume hood 100, with each forward friction wheel 231, 232, 233 connected to a corresponding friction wheel on the other side of fume hood by a drive rod (not shown; see FIG. 2). The flexible couplings (not shown) on the other side of fume hood 100 follow a similar path around rear friction wheels (not visible) and drive wheels (not shown) to raise each side of each window 111, 112, 113 simultaneously. The corresponding flexible couplings on the other side of fume hood 100 are also connected either to another counterweight such that each window 111, 112, 113 has two counterweights, or to the same counterweights 261, 262, 263 to which each flexible coupling 251, 252, 253 is attached, respectively, such that each window 111, 112, 113 has a single counterweight 261, 262, 263. However, in any of these alternate embodiments, there is no need for a second motor on the opposing side.

FIG. 2 shows a top perspective partial view of fume hood 100 in which one embodiment of common drive mechanism 300 can be seen. Common drive mechanism 300 is comprised of, in this embodiment, motor 210, first forward drive shaft 281, second forward drive shaft 282, third forward drive shaft 283, first rear drive shaft 284, second rear drive shaft 285, third rear drive shaft 286, first drive wheel drive shaft 287, second drive wheel drive shaft 288, third drive wheel drive shaft 289, first inner drive wheel 224, second inner drive wheel 225, third inner drive wheel 226, and fourth inner drive wheel 227. Each forward drive shaft 281, 282, 283 connects each forward friction wheel 231, 232, 233 to its counterpart (not shown) on the other side of fume hood 100; each rear drive shaft 284, 285, 284 connects each rear friction wheel 221, 222, 223 to its counterpart (not shown) on the other side of fume hood 100; and each drive wheel drive shaft 287, 288, 289 connects each drive wheel 221, 222, 223 to its counterpart (not shown) on the other side of fume hood 100.

The combination of drive wheel drive shafts 287, 288, 289, inner drive wheels 224, 225, 226, 227, and flexible drive couplings 271, 272 are just one embodiment of a “mechanical interconnection” between the window positioning mechanisms. The mechanical interconnection, along with drive motor 210 comprise common drive mechanism 300. One of ordinary skill in the art will recognize that alternate mechanical interconnections could be used, so long as a single drive motor 210 simultaneously raises or lowers each window 111, 112, 113 of multi-window movable sash member 110.

As an example, fewer than nine (9) drive shafts can be employed, including zero (0) drive shafts. There is, however, a potential for uneven lifting of each window 111, 112, 113 if no drive shafts are used, which may result in pinching of windows 111, 112, 113 within the window tracks (not shown). Thus, in one alternate embodiment, fume hood 100 is constructed with either first forward drive shaft 281, first rear drive shaft 284, or first drive wheel drive shaft 287 is employed. Similarly, in this alternate embodiment of fume hood 100, fume hood 100 is constructed with only one of second forward drive shaft 282, second rear drive shaft 285, and second drive wheel drive shaft 288 and with only one of third forward drive shaft 283, third rear drive shaft 286, and third drive wheel drive shaft 289.

In the embodiment of common drive mechanism 300 shown in FIG. 2, motor 210 and motor drive wheel 212 can be appreciated. Motor drive wheel 212 functionally engages first flexible drive coupling 271 on both sides, which mechanically engages and rotates first inner drive wheel 224 and second inner drive wheel 225. First inner drive wheel 224 and second inner drive wheel 225 are each fixedly secured to first drive wheel shaft 287 and second drive wheel shaft 288, respectively, by any means known in the art. On the other side of fume hood wall 130, also fixedly secured to first drive wheel shaft 287 is the first drive wheel (not visible, but can be seen in FIG. 1). Thus, as motor drive wheel 212 is rotated, it rotates the first drive wheel, which, in turn, moves first flexible coupling 251, raising and lowering the first window (not shown) of multi-window movable sash member (not shown).

Similarly, also mounted to second drive wheel drive shaft 288, and also on the other side of fume hood wall 130, is the second drive wheel (not visible, but can be seen in FIG. 1) which, as described with respect to FIG. 1, mechanically engages second flexible coupling 252, which is mechanically coupled to second forward friction wheel 232 and second rear friction wheel 242. Thus, as motor 210 operates and motor drive wheel 212 is rotated, second window (not shown) is also raised and lowered.

Also fixedly mounted on second drive wheel drive shaft 288 is third inner drive wheel 226, which is mechanically coupled to fourth inner drive wheel 227 via second flexible drive coupling 272. Fourth inner drive wheel 227 is fixedly secured to third drive wheel drive shaft 289. Also secured to third drive wheel drive shaft 289, but on the other side of fume hood wall 130, is the third drive wheel (not shown, but visible in FIG. 1). Thus, as drive motor 210 is operated, it also rotates third drive wheel drive shaft 289, fourth inner drive wheel 227, the third drive wheel, and third forward friction wheel 233, and third rear friction wheel 243 via third flexible coupling 253. The result is that a single motor 210, through common drive mechanism 300, simultaneously raises and lowers each window of the multi-window movable sash member.

FIG. 2 shows one example of common drive mechanism 300, i.e., the means by which drive motor 210 imparts movement of first flexible coupling 251, second flexible coupling 252, and third flexible coupling 253 via a “mechanical interconnection” to simultaneously raise and lower each window of the multi-window movable sash member. However, there are many alternate embodiments of the mechanical interconnection that can be used. For example, motor 210 can be positioned to directly engage one of drive shafts 281, 282, 283, 284, 285, 286, 287, 288, or 289. In alternate embodiments, motor 210 mechanically engages any of inner drive wheels 224, 225, 226, or 227 directly. In yet another alternate embodiment, motor 210 and motor drive wheel 212 are positioned between third inner drive wheel 226 and fourth inner drive wheel 227 such that motor drive wheel 212 is positioned within and engages on both ends second flexible drive coupling 272. In still further alternate embodiments, motor 210 is positioned on the outside of fume hood wall 130, i.e., on the same side of fume hood wall 130 as forward friction wheels 231, 232, 233, rear friction wheels 241, 242, 243, and flexible couplings 251, 252, 253, such that the components of common drive mechanism 300 are all positioned outside of fume hood wall 130. In yet another alternate embodiment, motor 210 is positioned outside of fume hood wall 130, but common drive mechanism 300 is still positioned within fume hood wall 130, as that shown in FIG. 2. That is, the drive mechanism is positioned outside of fume hood wall 130, but the mechanism by which all three windows are connected such that they raise and lower simultaneously is located within fume hood wall 130. In either of these last two embodiments, motor can mechanically engage any of forward friction wheels 231, 232, 233, rear friction wheels 241, 242, 243, drive wheels 221, 222, 223, or flexible couplings 251, 252, 253 directly. In a still further alternate embodiment, motor 210 is positioned such that it drives one or more of forward drive shafts 281, 282, 283, rear drive shafts 284, 285, 286, and/or drive wheel drive shafts 287, 288, 289. Motor 210 can be positioned almost anywhere; the key is the interconnection between the three sets of front friction wheels 231, 232, 233, rear friction wheels 241, 242, 243, and three flexible couplings 251, 252, 253 that allows the a single motor 210 to drive all three windows of the multi-window movable sash member.

Furthermore, the embodiment shown in FIG. 2 shows nine (9) total drive shafts: three (3) forward drive shafts 281, 282, 283, three (3) rear drive shafts 284, 285, 286, and three (3) drive wheel drive shafts 287, 288, 289. However, alternate embodiments need not have all nine (9). Rather, common drive mechanism 300 only needs one (1) drive shaft for each window. That is, common drive mechanism 300 need only have one (1) of first forward drive shaft 281, first rear drive shaft 284, and first drive wheel drive shaft 287; one (1) of second forward drive shaft 282, second rear drive shaft 285, and second drive is wheel drive shaft 288; and one (1) of third forward drive shaft 283, third rear drive shaft 286, and third drive wheel drive shaft 289. However, two (2) drive shafts or three (3) drive shafts (as shown in FIG. 2) from each group can also be employed. Thus, the presence of at least one drive shaft from each group permits each side of each window of the multi-window movable sash member to be raised and lowered simultaneously.

Referring again to FIG. 1, in order to provide access to the interior of walk-in fume hood 100, in one embodiment, all three windows 111, 112, 113 of movable sash member 110 must be raised. However, in order to provide a user access, first window 111 must be raised three times the distance that third window 113 must be raised, and second window 112 must be raised twice the distance that third window 113 must be raised. If a single-windowed sash were used, it would extend several feet beyond the top of fume hood 100 when in the fully-opened position. To accomplish this, a gearing system is used in which the ratios between forward friction wheels 231, 232, 233, rear friction wheels 241, 242, 243, and drive wheels 221, 222, 223 must be adjusted. In this embodiment, since windows 111, 112, 113 must be raised distances with a ratio of 3:2:1, the gearing must be ratioed similarly. That is, the ratio of the diameters of first drive wheel 221 to first forward drive wheel 231 to first rear drive wheel 241 is 3:1:1; the ratio of the diameters of second drive wheel 222 to second forward drive wheel 232 to second rear friction wheel 242 is 2:2:2; and the ratio of the diameters of third drive wheel 223 to third forward friction wheel 233 to third rear friction wheel 243 is 1:3:3. Thus, as motor 210 is driven, through using common drive mechanism 300, all three windows 111, 112, 113 of multi-window movable sash member 110 are simultaneously raised, but at specified different speeds such that in the lowermost position, windows 111, 112, 113 close access opening 120, and when in the uppermost position, they maximize access opening 120 to provide a user access to within fume hood 100. One of ordinary skill in the art will recognize that any ration can be used to control the speed of the ascent and descent of the movable sash member and will depend on the manufacturer's preference and the motor used.

Motor 210 can be an electrical motor, a gasoline motor, a battery-operated motor, a pneumatic motor (which is especially applicable for applications in which hazardous fumes or liquids are present because a pneumatic motor reduces the possibility of igniting the fumes or liquids), or any other motor known to those of ordinary skill in the art. In the embodiment shown in FIG. 2, motor 210 is a 1/50 hp motor, model number 31K156N-AWU, as manufactured by Oriental Motor, that operates at 1450 rpm at 14.6 ounce-inches

In an alternate embodiment, motor 210 is further comprised of clutch 211. By using clutch 211, motor 210 is decoupled from flexible coupling 242, allowing a reduction in the burden and allowing each window of the multi-window movable sash member to be manually raised and lowered with less force.

As used herein, “flexible coupling” refers to a chain, a band, a belt, a rope, or any other material well-known to those of ordinary skill in the art which provides sufficient strength and flexibility for proper operation, as discussed. The term “friction wheel” refers to a generally circular and rotatable wheel that changes the direction of the flexible coupling and around which the flexible coupling passes. In the embodiments shown, flexible couplings 251, 252, 253 and flexible drive couplings 271, 272 are a chain, and forward friction wheels 231, 232, 233, rear friction wheels 241, 242, 243, drive wheels 221, 222, 223, and inner drive wheels 224, 225, 226, 227 are sprockets, such that teeth on forward friction wheels 231, 232, 233, rear friction wheels 241, 242, 243, drive wheels 221, 222, 223, and inner drive wheels 224, 225, 226, 227 fit within holes on flexible couplings 251, 252, 253 and flexible drive couplings 271, 272, creating a mechanical engagement. In one embodiment, flexible couplings 251, 252, 253, and flexible drive couplings 271, 272 are an ANSI number 35 roller chain with a ⅜″ pitch and forward friction wheels 231, 232, 233, rear friction wheels 241, 242, 243, drive wheels 221, 222, 223, and inner drive wheels 224, 225, 226, 227 are sprockets as manufactured by US Tsubaki, part number P/N 35B24F. In an alternate embodiment of flexible couplings 251, 252, 253, and flexible drive couplings 271, 272, are a chain as manufactured by US Tsubaki, part number RS35. However, one of ordinary skill in the art will recognize that other types of chains and sprockets can be used.

In an alternate engagement mechanism, forward drive wheel 231, 232, 233, rear friction wheels 241, 242, 243, drive wheels 221, 222, 223, and inner drive wheels 224, 225, 226, 227 are a wheel, and flexible couplings 251, 252, 253 and flexible drive couplings 271, 272 are a cable. In one embodiment, the cable is a polypropylene-impregnated cable with a maximum tensile strength of 1700 pounds of force. However, in alternate embodiments, flexible couplings 251, 252, 253 and flexible drive couplings 271, 272 can also be coated or uncoated rope, coated or uncoated wire rope, or any other material known in the art that provides sufficient strength and flexibility. The same mechanics are employed as with the embodiment employing a chain and sprocket, but rather than using a combination of teeth and corresponding holes on the chain, the engagement mechanism is a strictly frictional engagement. In one embodiment, to increase the friction between flexible couplings 251, 252, 253 and flexible drive couplings 271, 272 and the inner surfaces of forward friction wheels 231, 232, 233, rear friction wheels 241, 242, 243, drive wheels 221, 222, 223, and inner drive wheels 224, 225, 226, 227 are coated with a urethane coating, creating a high coefficient of friction therebetween.

Furthermore, although the embodiments shown herein all employ the same engagement mechanism, it should be understood that window positioning mechanisms 201, 202, 203 could employ one type of engagement mechanism while common drive mechanism 300 could employ another. In addition, each window positioning system could different engagement mechanisms. Furthermore, the engagement mechanism on one side of fume hood 100 could be different from that used on the other side of fume hood 100.

While several embodiments of the present invention have been shown and described, it is to be understood that the invention is not limited thereto, but is susceptible to numerous changes and modifications as known to a person skilled in the art, and it is intended that the present invention not be limited to the details shown and described herein, but rather cover all such changes and modifications as are obvious to one of ordinary skill in the art.

What is claimed is:

1. A fume hood comprised of:
a first side wall and a second side wall;
a back wall;
a top wall, said first side wall, said second side wall, said back wall, and said top wall defining a work area;
an access opening for providing a user access to said work area;
a multi-window movable sash member comprised of a plurality of windows, said multi-window movable sash member disposed for vertical movement across said access opening to vary an effective size thereof;
a plurality of window positioning mechanisms, one of said plurality of window positioning mechanisms for each of said plurality of windows of said multi-window movable sash member; and
a common drive mechanism to drive each of said plurality of window positioning mechanisms and simultaneously raise or lower each of said plurality of windows of said multi-window movable sash member.

2. The fume hood of claim 1, wherein said fume hood is a walk-in fume hood.

3. The fume hood of claim 1, wherein each of said plurality of window positioning mechanisms is comprised of:
a forward friction wheel;
a drive wheel;
a rear friction wheel; and
a flexible coupling, said flexible coupling mechanically engaging said forward friction wheel, said drive wheel, and said rear friction wheel, and said flexible coupling connected on a first end to one of said plurality of windows of said multi-window movable sash member and connected on a second end to one of a plurality of counterweights.

4. The fume hood of claim 1, wherein said common drive mechanism is comprised of:
a mechanical interconnection between each of said plurality of window positioning mechanisms, and
a drive motor mechanically engaging one of said window positioning mechanisms or said mechanical interconnection.

5. The fume hood of claim 4, wherein said mechanical interconnection is comprised of a first inner drive wheel disposed on a first drive wheel drive shaft, a second inner drive wheel and a third inner drive wheel disposed on a second drive wheel drive shaft, and a fourth inner drive wheel disposed on a third drive wheel shaft, a first flexible drive coupling functionally engaging said first inner drive wheel and said second inner drive wheel, and a second flexible drive coupling functionally engaging said third inner drive wheel and said fourth inner drive wheel.

6. The fume hood of claim 5, wherein said first inner drive wheel, said second inner drive wheel, said third inner drive wheel, and said fourth inner drive wheel are each a sprocket and said first flexible drive coupling and said second flexible drive coupling are a chain.

7. The fume hood of claim 5, wherein said first inner drive wheel, said second inner drive wheel, said third inner drive wheel, and said fourth inner drive wheel are each a wheel and said first flexible drive coupling and said second flexible drive coupling are selected from a group comprised of a coated rope, an uncoated rope, a coated wire rope, an uncoated wire rope, a cable, and a polypropylene-impregnated cable.

8. The fume hood of claim 3, wherein said forward friction wheels, said drive wheels, and said rear friction wheels are a sprocket and said flexible couplings are a chain.

9. The fume hood of claim 3, wherein said forward friction wheels, said drive wheels, and said rear friction wheels are a wheel and said flexible couplings are selected from a group comprised of a coated rope, an uncoated rope, a coated wire rope, an uncoated wire rope, a cable, and a polypropylene-impregnated cable.

10. The fume hood of claim 3, wherein said forward friction wheels, said drive wheels, and said rear friction wheels have ratioed diameters to raise and lower each of said plurality of windows of said multi-window movable sash member at a different speed.

11. The fume hood of claim 4, wherein said motor is selected from a group comprised of an electrical motor, a gasoline motor, a battery-operated motor, and a pneumatic motor.

12. The fume hood of claim 4, wherein said motor is further comprised of a clutch, said clutch permitting said motor to be decoupled from said common drive mechanism and allowing a reduction in the burden, allowing each window of said multi-window movable sash member to be moved manually.

13. A walk-in fume hood comprised of:
a first side wall and a second side wall;
a back wall;
a top wall, said first side wall, said second side wall, said back wall, and said top wall defining a work area;
an access opening for providing a user access to said work area;
a multi-window movable sash member comprised of a plurality of windows disposed for vertical movement across said access opening to vary an effective size thereof;
a plurality of window positioning mechanisms, one of said plurality of window positioning mechanisms for each of said plurality of windows of said multi-window movable sash member; and
a common drive mechanism to simultaneously raise or lower each of said plurality of windows of said multi-window movable sash member, said common drive mechanism comprised of:
a mechanical interconnection between each of said plurality of window positioning mechanisms, and
a drive motor mechanically engaging one of said window positioning mechanisms or said mechanical interconnection.

14. The walk-in fume hood of claim 13, wherein each of said plurality of window positioning mechanisms is comprised of:
a forward friction wheel;
a drive wheel;
a rear friction wheel; and
a flexible coupling, said flexible coupling mechanically engaging said forward friction wheel, said drive wheel, and said rear friction wheel, and said flexible coupling connected on a first end to one of said plurality of windows of said multi-window movable sash member and connected on a second end to one of a plurality of counterweights.

15. The walk-in fume hood of claim 13, wherein said mechanical connection is comprised of a first inner drive wheel disposed on a first drive wheel drive shaft, a second inner drive wheel and a third inner drive wheel disposed on a second drive wheel drive shaft, and a fourth inner drive wheel disposed on a third drive wheel shaft, a first flexible drive coupling functionally engaging said first inner drive wheel and said second inner drive wheel, and a second flexible drive coupling functionally engaging said third inner drive wheel and said fourth inner drive wheel.

16. The walk-in fume hood of claim 15, wherein said first inner drive wheel, said second inner drive wheel, said third inner drive wheel, and said fourth inner drive wheel are each a sprocket and said first flexible drive coupling and said second flexible drive coupling are a chain.

17. The walk-in fume hood of claim 15, wherein said first inner drive wheel, said second inner drive wheel, said third inner drive wheel, and said fourth inner drive wheel are each a wheel and said first flexible drive coupling and said second flexible drive coupling are selected from a group comprised of a coated rope, an uncoated rope, a coated wire rope, an uncoated wire rope, a cable, and a polypropylene-impregnated cable.

18. The walk-in fume hood of claim 14, wherein said forward friction wheels, said drive wheels, and said rear friction wheels are a sprocket and said flexible couplings are a chain.

19. The walk-in fume hood of claim 14, wherein said forward friction wheels, said drive wheels, and said rear friction wheels are a wheel and said flexible couplings are selected from a group comprised of a coated rope, an uncoated rope, a coated wire rope, an uncoated wire rope, a cable, and a polypropylene-impregnated cable.

20. The walk-in fume hood of claim 14, wherein said forward friction wheels, said drive wheels, and said rear friction wheels have ratioed diameters to control a relative raising and lowering speed of each of said plurality of windows of said multi-window movable sash member.

21. The walk-in fume hood of claim 13, wherein said motor is selected from a group comprised of an electrical motor, a gasoline motor, a battery-operated motor, and a pneumatic motor.

22. The fume hood of claim 13, wherein said motor is further comprised of a clutch, said clutch permitting said motor to be decoupled from said common drive mechanism and allowing a reduction in the burden, allowing each window of said multi-window movable sash member to be manually moved.

23. A device comprised of:
a first side wall and a second side wall;
a back wall;
a top wall, said first side wall, said second side wall, said back wall, and said top wall defining a work area;
an access opening for providing a user access to said work area;
a multi-window movable sash member comprised of a plurality of windows disposed for vertical movement across said access opening to vary an effective size thereof;
a plurality of window positioning mechanisms, one of said plurality of window positioning mechanisms for each of said plurality of windows of said multi-window movable sash member, wherein each of said plurality of window positioning mechanisms is comprised of:
a forward friction wheel;
a drive wheel;
a rear friction wheel; and
a flexible coupling, said flexible coupling mechanically engaging said forward friction wheel, said drive wheel, and said rear friction wheel, and said flexible coupling connected on a first end to one of said plurality of windows of said multi-window movable sash member and connected on a second end to one of a plurality of counterweights; and
a common drive mechanism to simultaneously raise or lower each of said plurality of windows of said multi-window movable sash member, said common drive mechanism comprised of:
a mechanical interconnection between each of said plurality of window positioning mechanisms, and
a drive motor mechanically engaging one of said window positioning mechanisms or said mechanical interconnection.

24. The device of claim 23, wherein said fume hood is a walk-in fume hood.

25. The device of claim 23, wherein said mechanical connection is comprised of a first inner drive wheel disposed on a first drive wheel drive shaft, a second inner drive wheel and a third inner drive wheel disposed on a second drive wheel drive shaft, and a fourth inner drive wheel disposed on a third drive wheel shaft, a first flexible drive coupling functionally engaging said first inner drive wheel and said second inner drive wheel, and a second flexible drive coupling functionally engaging said third inner drive wheel and said fourth inner drive wheel.

26. The device of claim 25, wherein said first inner drive wheel, said second inner drive wheel, said third inner drive wheel, and said fourth inner drive wheel are each a sprocket and said first flexible drive coupling and said second flexible drive coupling are a chain.

27. The device of claim 25, wherein said first inner drive wheel, said second inner drive wheel, said third inner drive wheel, and said fourth inner drive wheel are each a wheel and said first flexible drive coupling and said second flexible drive coupling are selected from a group comprised of a coated rope, an uncoated rope, a coated wire rope, an uncoated wire rope, a cable, and a polypropylene-impregnated cable.

28. The device of claim 23, wherein said forward friction wheels, said drive wheels, and said rear friction wheels are a sprocket and said flexible couplings are a chain.

29. The device of claim 23, wherein said forward friction wheels, said drive wheels, and said rear friction wheels are a wheel and said flexible couplings are selected from a group comprised of a coated rope, an uncoated rope, a coated wire rope, an uncoated wire rope, a cable, and a polypropylene-impregnated cable.

30. The device of claim 23, wherein said forward friction wheels, said drive wheels, and said rear friction wheels have ratioed diameters to control a relative raising and lowering speed of each of said plurality of windows of said multi-window movable sash member.

31. The device of claim 23, wherein said motor is selected from a group comprised of an electrical motor, a gasoline motor, a battery-operated motor, and a pneumatic motor.

32. The device of claim 23, wherein said motor is further comprised of a clutch, said clutch permitting said motor to be decoupled from said common drive mechanism and allowing a reduction in the burden, allowing each window of said multi-window movable sash member to be manually moved.

33. A drive mechanism for simultaneously raising or lowering a plurality of movable sash members of a multi-sash fume hood unit, said drive mechanism comprised of:
a first inner drive wheel disposed on a first drive wheel drive shaft;
a second inner drive wheel and a third inner drive wheel disposed on a second drive wheel drive shaft;
a fourth inner drive wheel disposed on a third drive wheel shaft;
a first flexible drive coupling functionally engaging said first inner drive wheel and said second inner drive wheel;
a second flexible drive coupling functionally engaging said third inner drive wheel and said fourth inner drive wheel;
a first window positioning mechanism mechanically connected to said first drive wheel drive shaft and to a first movable sash member of said plurality of movable sash members;
a second window positioning mechanism mechanically connected to said second drive wheel drive shaft and to a second movable sash member of said plurality of movable sash members;
a third window positioning mechanism mechanically connected to said third drive wheel drive shaft and to a third movable sash member of said plurality of movable sash members; and
a drive motor mechanically engaging said first inner drive wheel, said second inner drive wheel, said third inner drive wheel, said fourth inner drive wheel, said first drive wheel drive shaft, said second drive wheel drive shaft, said third drive wheel drive shaft, said first flexible drive coupling, or said second flexible drive coupling such that said drive motor simultaneously rotates each of said first drive wheel drive shaft, said second drive wheel drive shaft, and said third drive wheel drive shaft, such that each of said plurality of movable sash members are simultaneously raised or lowered.

34. The drive mechanism of claim 33, wherein said first inner drive wheel, said second inner drive wheel, said third inner drive wheel, and said fourth inner drive wheel are each a sprocket and said first flexible drive coupling and said second flexible drive coupling are a chain.

35. The drive mechanism of claim 33, wherein said first inner drive wheel, said second inner drive wheel, said third inner drive wheel, and said fourth inner drive wheel are each a wheel and said first flexible drive coupling and said second flexible drive coupling are selected from a group comprised of a coated rope, an uncoated rope, a coated wire rope, an uncoated wire rope, a cable, and a polypropylene-impregnated cable.

36. The drive mechanism of claim 35, wherein said first window positioning mechanism, said second window positioning mechanism, and said third window positioning mechanism are each comprised of:
a forward friction wheel;
a drive wheel;
a rear friction wheel; and
a flexible coupling, said flexible coupling mechanically engaging said forward friction wheel, said drive wheel, and said rear friction wheel, and said flexible coupling connected on a first end to one movable sash member of said plurality of movable sash members and connected on a second end to one of a plurality of counterweights.

37. The drive mechanism of claim 36, wherein each forward friction wheel, each drive wheel, and each rear friction wheel is a sprocket and each flexible coupling is a chain.

38. The drive mechanism of claim 36, wherein each forward friction wheel, each drive wheel, and each rear friction wheel is a wheel and each flexible coupling is selected from a group comprised of a coated rope, an uncoated rope, a coated wire rope, an uncoated wire rope, a cable, and a polypropylene-impregnated cable.

39. The drive mechanism of claim 36, wherein said first forward friction wheel, said second forward friction wheel, said third forward friction wheel, said first drive wheel, said second drive wheel, said third drive wheel, said first rear friction wheel, said second rear friction wheel, and said third rear friction wheel have ratioed diameters to control a relative raising and lowering speed of each of said plurality of windows of said multi-window movable sash member.

40. The drive mechanism of claim 33, wherein said motor is selected from a group comprised of an electrical motor, a gasoline motor, a battery-operated motor, and a pneumatic motor.

41. The drive mechanism of claim 33, wherein said motor is further comprised of a clutch, said clutch permitting said motor to be decoupled from said common drive mechanism and allowing a reduction in the burden, allowing each window of said multi-window movable sash member to be manually moved.
